(19) United States
(12) Patent Application Publication
(10) Pub. No.: US 2012/0218194 A1
(43) Pub. Date: Aug. 30, 2012

(54) VIRTUAL KEYBOARD FEEDBACK

(76) Inventor: Richard Ian Silverman, Cupertino, CA (US)

(21) Appl. No.: 13/037,124

(22) Filed: Feb. 28, 2011

(51) Int. Cl. G06F 3/041

(52) U.S. Cl. 345/173

(57) ABSTRACT

Feedback is provided for a virtual keyboard. A virtual key is displayed by a touch-sensitive display. The virtual key has a center zone and a plurality of peripheral zones surrounding the center zone. A first tone is sounded when the virtual key is touched within the center zone. A second tone is sounded when the virtual key is touched in a first peripheral zone. A third tone is sounded when the virtual key is touched in a second peripheral zone. The first tone is different than the second tone. The first tone is different than the third tone.

### BACKGROUND

Virtual keyboards can be created on touch sensitive displays by displaying images of physical keys on a flat-screen surface. The virtual keyboards can be configured, for example, in a variety of standardized keyboards (QWERTY, Numeric Keypad) or custom keyboards for various custom applications. The touch-sensitive display detects when an image of a physical key is touched, allowing the input of data based on touch location.

### SUMMARY

In accordance with embodiments of the present invention, feedback is provided for a virtual keyboard. A virtual key is displayed by a touch-sensitive display. The virtual key has a center zone and a plurality of peripheral zones surrounding the center zone. A first tone is sounded when the virtual key is touched within the center zone. A second tone is sounded when the virtual key is touched in a first peripheral zone. A third tone is sounded when the virtual key is touched in a second peripheral zone. The first tone is different than the second tone. The first tone is different than the third tone.

### BRIEF DESCRIPTION OF THE DRAWINGS

FIG. 1 is a simplified block diagram of a computing system with a touch sensitive display in accordance with an embodiment of the invention.

FIG. 2 shows a simplified virtual keyboard displayed on the touch sensitive display shown in FIG. 1 in accordance with an embodiment of the invention.

FIG. 3 is a simplified illustration used to describe how touch of a virtual key on the touch sensitive display shown in FIG. 1 is processed in accordance with an embodiment of the invention.

FIG. 4 is a flow diagram illustrating operation of the virtual keyboard shown in FIG. 2 in accordance with an embodiment of the invention.

FIG. 5 is an example of a simplified user interface that can be used to vary parameters of virtual keys within a virtual keyboard in accordance with an embodiment of the invention.

FIG. 6 is a flow diagram illustrating the process by which the parameters of a virtual key are varied in accordance with an embodiment of the invention.

### DESCRIPTION OF THE EMBODIMENT

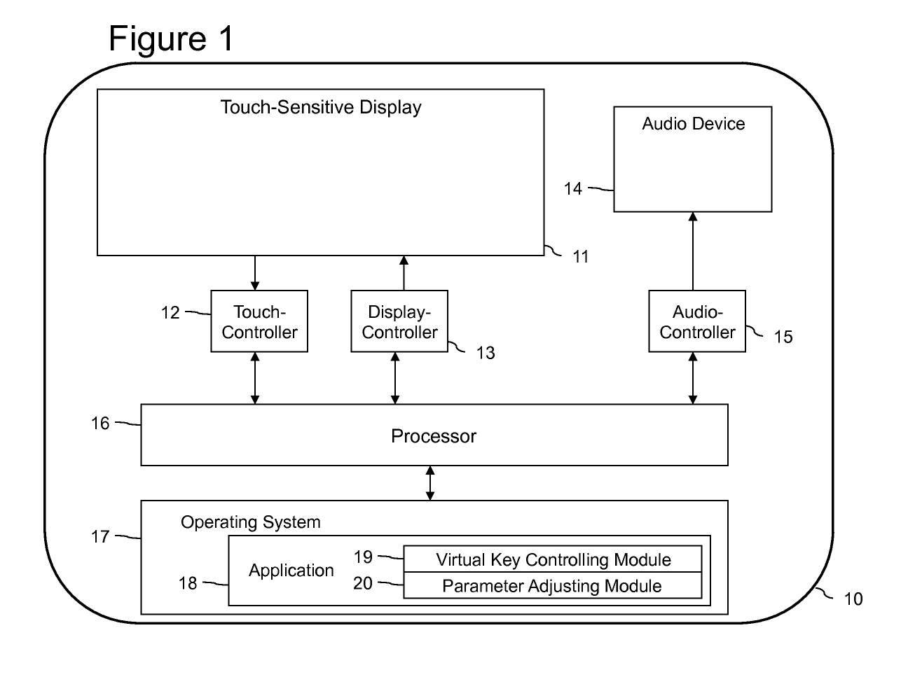

FIG. 1 is a simplified block diagram of a computing system 10 with a touch sensitive display 11. A touch controller 12 and a display controller 13 provide an interface between touch sensitive display 11 and a processor 16.

An audio device 14 provides sound feedback to a user using a virtual keyboard displayed on touch sensitive display 11. An audio controller 15 provides an interface between audio device 14 and processor 16. The virtual keyboard is implemented using application module 18 running within an operating system 17. A virtual key control module 19 provides control for the virtual keyboard. A parameter adjusting module 20 allows a user to adjust parameters of the virtual keyboard.

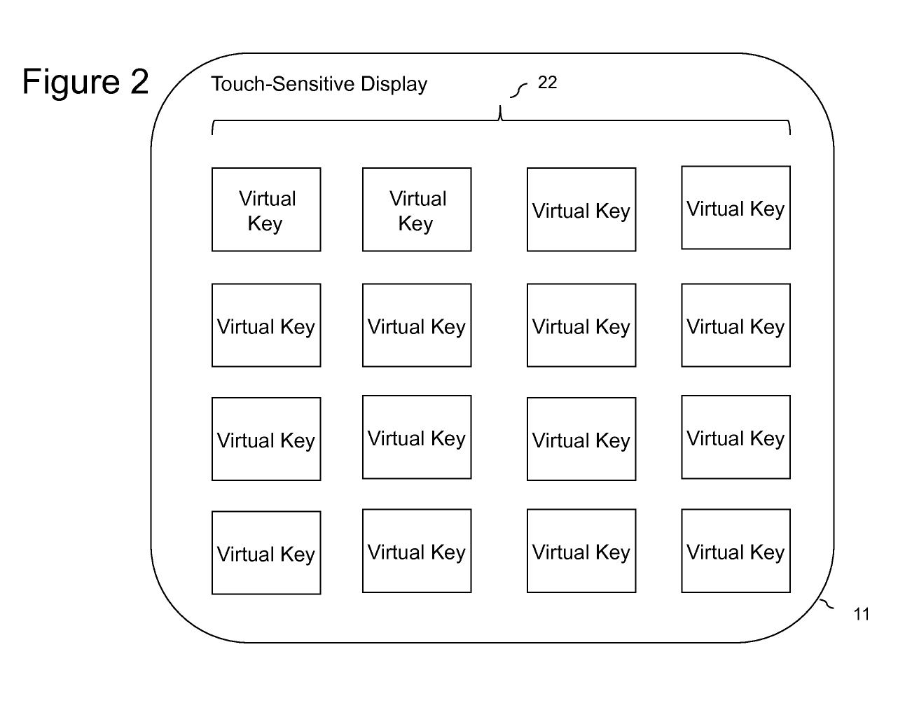

FIG. 2 shows a simplified virtual keyboard 22 displayed on touch sensitive display 11. Virtual keyboard 22 is composed of virtual keys that can be arranged, for example, in a variety of keyboard patterns such as for a QWERTY keyboard, a numeric keypad, or a custom key arrangement. When touch sensitive display 11 senses that a user has touched a virtual key displayed on touch sensitive display 11, the value for the key is input into computing system 10.

One disadvantage that virtual keyboards can have over physical keyboards is the lack of physical feedback. Physical keyboards give tactile feedback to a user indicating to a user location of fingers on the physical keyboard. Virtual keyboards are typically implemented on flat screen surfaces so that it is impractical to provide tactile feedback indicating user location of keys on the flat screen surface.

In various embodiments of the present invention, audio feedback is provided to a user to aid the user in correctly positioning fingers on virtual keyboard 22. The audio feedback can be configured so that a user will receive sufficient feedback to allow correct positioning of fingers and so that the user will not receive audio feedback that is too complex or otherwise unhelpful when the user, for example, is typing many words per minute or otherwise pressing multiple keys in a single second.

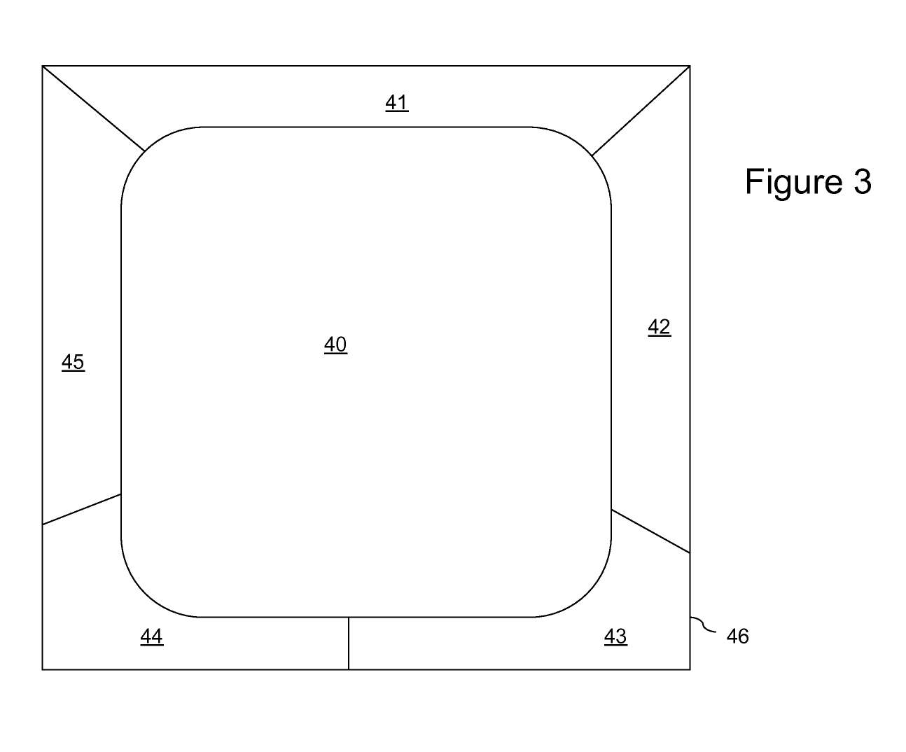

FIG. 3 is used to illustrate how touch location within a virtual key 46 from virtual keyboard 22 is processed to provide audio feedback to a user to aid the user in correctly positioning fingers on virtual keyboard 22.

In accordance with embodiments of the present invention, when a user touches a location within virtual key 46, the user will receive feedback based on location within virtual key 46. For example, a touch detected within a center region 40 of virtual key 46 will result in a first assigned audio tone being sounded by audio device 14. A touch detected within one of peripheral regions 41, 42, 43, 44, and 45 will result in an assigned audio tone other than the first audio tone being sounded by audio device 14. For example the audio tone sounded by audio device 14 differs dependent upon which region is the center of a detected touch. The tone can vary from region to region based, for example, on pitch, volume, brightness or duration. The tone can also comprise a harmony of two or more notes, and different harmonies or dissonance between the multiple notes can be sounded by audio device 14 to provide feedback to a user as to which region is the center of a detected touch.

Typically, center region 40 will cover more than half the area of virtual key 46. As long as a user touches virtual keys within their center region, the first assigned audio tone will continue to give feedback to a user indicating the user's fingers are properly located over the virtual keyboard. When the user touches a virtual key outside its center region, the alternate audio tone(s) will indicate to the user that the user's finger has touched a virtual key on its outside edge thereby providing feedback to the user that indicates it is necessary to correct positioning of the finger with respect to the virtual key.

In the example shown in FIG. 3, there are five regions surrounding center region 40. Each of peripheral regions 41 through 45 can be configured so as to have a distinct tone that will vary from the other regions. For example, the tone varies based on one or more of pitch, volume, duration, harmony or dissonance. The differing tones warn the user that the user has touched a virtual key with a touch centering outside center region 40. The particular variation in tone can indicate to the user whether the touch is in a peripheral region that is left, right, above or below center region 40. This feedback will encourage the user to re-position hands so that in the future virtual keys will be pressed with touches inside center region 40. While FIG. 3 shows five peripheral regions 41 through 45 surrounding center region 40, various embodiments of the invention allow a user to select the number of peripheral regions. For example, a user may find it most helpful to select just two peripheral regions or four peripheral regions to surround center region 40.

In one embodiment, when a user's fingers touches both center region 40 and a peripheral region, touch sensitive display can determine in which region the touch is detected and audio device 14 can emit the tone only for the region in which the touch is detected. Alternatively, when a user's finger touches both center region 40 and a peripheral region, audio device 14 can emit the tones for all the regions that are touched.

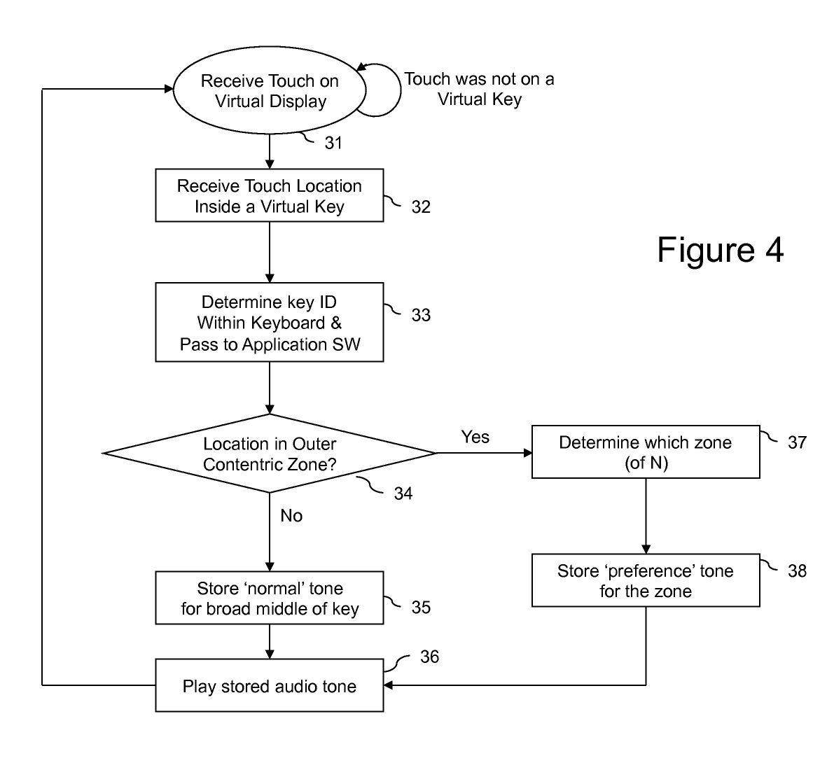

FIG. 4 is a flow diagram illustrating virtual key controller 19 controlling operation of virtual keyboard 22, shown in FIG. 2. In a block 31, touch sensitive display detects a touch. A determination is made as to whether the touch was made within a region of a virtual key within virtual keyboard 22. If not, nothing is done. Depending upon how the keyboard is implemented, the determination of the location of the touch can be made upon the initial touch on the display or upon the release of the touch.

If the touch was made on a virtual key within virtual keyboard 22, in a block 32, a touch location inside a virtual key is identified. In a block 33, the particular virtual key touched is identified and identification of the touch virtual key is passed to application module 18 for application processing.

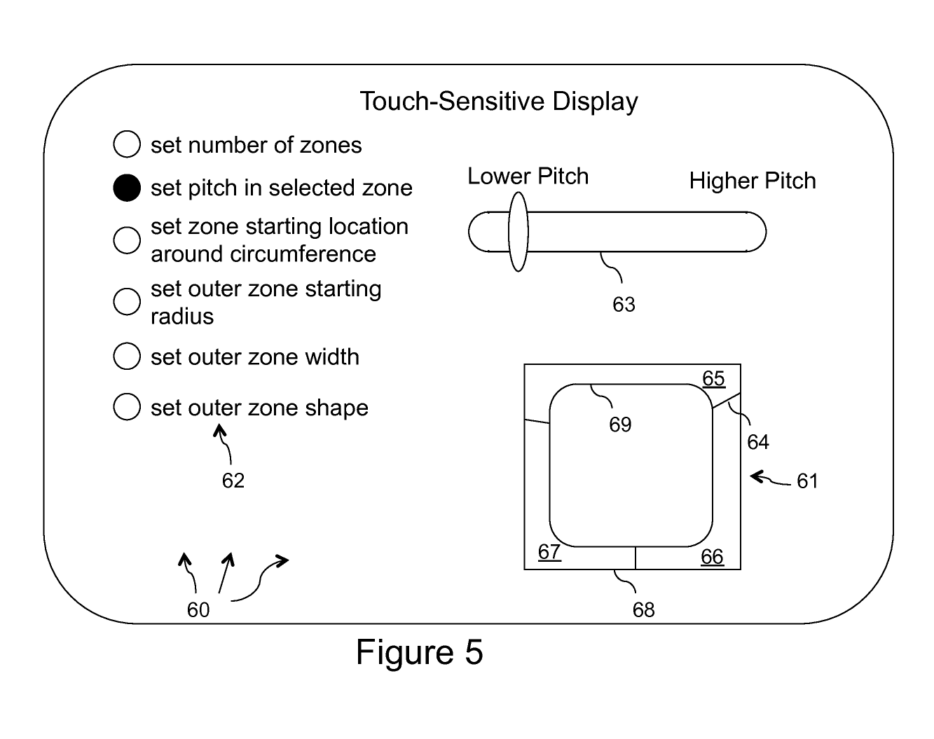

In a block 34, a determination is made as to whether the touch was detected in one of the peripheral regions of the virtual key (e.g., one of peripheral regions 41 through 45 of virtual key 46). If not, in a block 35, the tone for the central region of the virtual key (e.g., central region 40 of virtual key 46 shown in FIG. 5) is accessed and stored for play by audio device 14. In a block 36, the stored tone is played by audio device 14, shown in FIG. 1.

If in block 34 the touch was detected in one of the peripheral regions of the virtual key (e.g., one of peripheral regions 41 through 45 of virtual key 46), in a block 37, the particular peripheral region receiving the touch is identified. In a block 38, the tone for the particular peripheral region receiving the touch is accessed and stored for play by audio device 14. In a block 36, the stored tone is played.

FIG. 5 provides an example of a user interface 60 that can be used to vary parameters for virtual keys within virtual keyboard 22. In an area 62, a user can select a parameter to vary by selecting a corresponding radio button. For example, the following parameters are listed in area 62: set number of zones, set tone pitch in any zone, set zone starting location around circumference, set outer zone staring radius, set outer zone width, and set outer zone shape. In other embodiments, fewer or a greater number of parameters can be listed. For example, a parameter could be included indicating whether a tone with multiple pitches would be sounded when more than one region is touched in a virtual key. Tone duration, harmony and dissonance can also be included as variable parameters in area 62. And so on.

A visual display 61 of a virtual key is provided to give a user feedback into results of parameter changes. For example, when a user varies number of zones, the selected number of zones is shown in visual display 61. For example, currently three peripheral zones 65, 66 and 67 are shown. When the user sets a different number of zones, the number selected by the user is reflected by changes to visual display 61.

Likewise, location of a zone starting location 64 shown in visual display 61 is varied based on a parameter value selected by the user. Location of an outer zone starting radius 69 shown in visual display 61 is varied based on a parameter selected by the user. Outer zone width determined by location of an outer zone outer radius 68 shown in visual display 61 is varied based on a parameter value selected by the user. The shape of the peripheral zones can be varied by the user by selecting different peripheral values.

A selector 63 is used to vary a particular parameter selected in area 62. For example, in area 62, the user has selected to vary the tone in a zone as indicated by the corresponding darkened radio button. To select a particular zone, the user can touch the particular zone on visual display 61. Then the user can use selector 63 to vary the parameter. In the example shown in FIG. 5, selector 63 is a slider. The location of the slider varies the pitch of the tone for the selected zone. Selector 63 can be implemented using something other than a slider. For example, instead of a slider, a user can select a discrete value from a list, and so on.

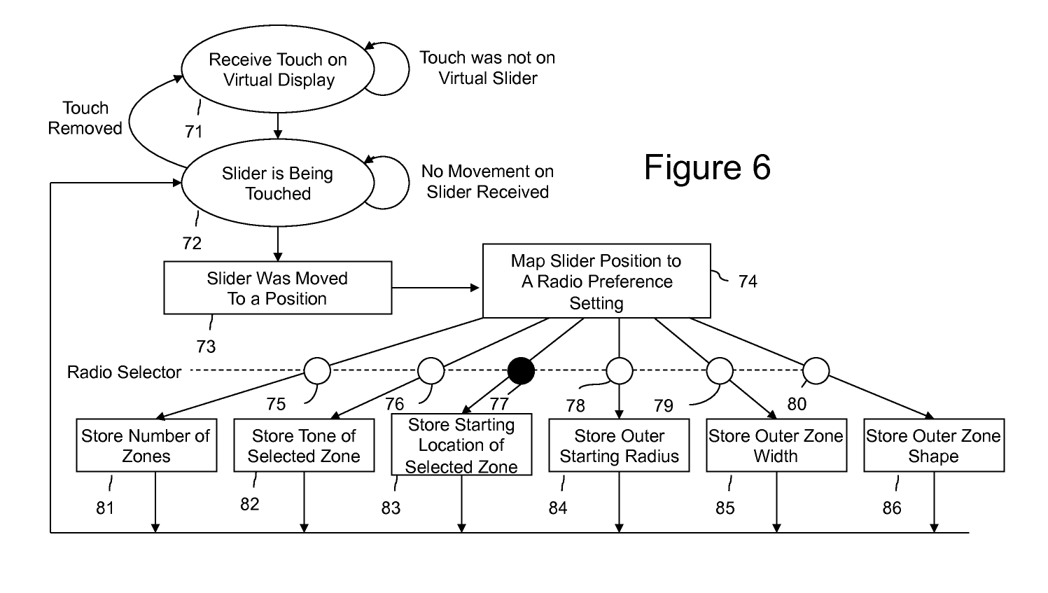

FIG. 6 is a flowchart illustrating how parameter adjusting module 20 adjusts parameters in response to user input from user interface 60 shown in FIG. 5.

In a block 71, touch sensitive display detects a touch. A determination is made as to whether the touch was made on selector 63. If not, nothing is done.

If the touch was made on selector 63, in a block 72, if the touch is removed with no new value being selected, control returns back to block 71. Block 73 is entered once a new selection is made, for example by moving touch location on a slider. In a block 74, a determination is made as to which parameter has been selected in area 62 of user interface 60, shown in FIG. 5.

If in area 62 the radio button for set number of peripheral zones is selected, in a block 81, a new value for the number of peripheral zones, selected in block 72, is stored.

If in area 62 the radio button for setting the pitch of zones is selected, in a block 82, a new value for the pitch of zones, selected in block 72, is stored.

If in area 62 the radio button for setting zone starting location around circumference is selected, in a block 83, a new value for the starting location around the circumference, selected in block 72, is stored.

If in area 62 the radio button for setting the outer zone starting location is selected, in a block 84, a new value for the outer zone starting location, selected in block 72, is stored.

If in area 62 the radio button for setting the outer zone width is selected, in a block 85, a new value for the outer zone width, selected in block 72, is stored.

If in area 62 the radio button for setting the outer zone shape is selected, in a block 86, a new value for the outer zone shape, selected in block 72, is stored.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

I claim:

1. A method for providing feedback for a virtual keyboard, the method comprising:
displaying a virtual key by a touch-sensitive display, the virtual key having a center zone and a plurality of peripheral zones surrounding the center zone;
sounding a first tone when the virtual key is touched within the center zone;
sounding a second tone when the virtual key is touched in a first peripheral zone; and,
sounding a third tone when the virtual key is touched in a second peripheral zone;
wherein the first tone is different than the second tone; and,
wherein the first tone is different than the third tone.

2. A method as in claim 1 wherein the first tone has a different pitch than the second tone.

3. A method as in claim 1 wherein the first tone has a different duration than the second tone and the third tone.

4. A method as in claim 1 wherein the first tone has a different volume than the second tone and the third tone.

5. A method as in claim 1, additionally wherein when the virtual key is touched within both the center zone and the first peripheral zone, both the first tone and the second tone are sounded.

6. A method as in claim 1, additionally comprising:
changing the number of peripheral zones per virtual key in response to user selections from a user interface.

7. A method as in claim 1, additionally comprising:
changing individual characteristics of each of the first tone, the second tone and the third tone in response to user selections from a user interface.

8. A method as in claim 7, wherein characteristics of the first tone include at least one of a pitch of the first tone, a duration of the first tone, a volume of the first tone, a duration of the first tone, and a brightness of the first tone.

9. A method as in claim 1, additionally comprising:
changing characteristics of the plurality of peripheral zones in response to user selections from a user interface.

10. A method as in claim 9, wherein characteristics of the plurality of peripheral zones include at least one of a number of peripheral zones, circumferential starting location of peripheral zones; starting radius for peripheral zones; radial width of peripheral zones; shape of peripheral zones.

11. A computing device comprising:
a touch-sensitive display;
a virtual keyboard displayed on the touch-sensitive display, the virtual keyboard including:
a plurality of virtual keys, each virtual key having a center zone and a plurality of peripheral zones surrounding the center zone; and,
an audio device;
wherein the audio device sounds a first tone when a virtual key in the plurality of virtual keys is touched within the center zone;
wherein the audio device sounds a second tone when a virtual key in the plurality of virtual keys is touched within a first peripheral zone;
wherein the audio device sounds a third tone when a virtual key in the plurality of virtual keys is touched within a second peripheral zone;
wherein the first tone is different than the second tone; and,
wherein the first tone is different than the third tone.

12. A computing device as in claim 11 wherein the first tone has a different pitch than the second tone and the third tone.

13. A computing device as in claim 11, additionally wherein when the virtual key is touched within both the center zone and the first peripheral zone, the audio device sounds both the first tone and the second tone.

14. A computing device as in claim 11, additionally comprising:
a user interface that allows a user to change the number of peripheral zones per virtual key.

15. A computing device as in claim 11, additionally comprising:
a user interface that allows a user to change individual characteristics of each of the first tone, the second tone and the third tone.

16. A computing device as in claim 11, additionally comprising:
a user interface that allows a user to change individual characteristics of each of the plurality of peripheral zones in response to user selections from a user interface.

17. A computing device as in claim 16, wherein characteristics of the plurality of zones include at least one of a number of peripheral zones, circumferential starting location of peripheral zones; starting radius for peripheral zones; radial width of peripheral zones; shape of peripheral zones.

18. An device for receiving user input, the device comprising:
a touch-sensitive display;
a virtual key displayed on the touch-sensitive display, the virtual key having a center zone and at least one peripheral zones surrounding the center zone;
a user interface that allows a user to change size of the at least one peripheral zone in response to user selections from a user interface; and,
an audio device;
wherein the audio device sounds a first tone when a virtual key in the plurality of virtual keys is touched within the center zone;
wherein the audio device sounds a second tone when a virtual key in the plurality of virtual keys is touched within a first peripheral zone; and
wherein the first tone is different than the second tone.

19. A computing device as in claim 18, wherein the user interface additionally allows a user to change individual characteristics of each of the first tone and the second tone.

20. A computing device as in claim 18, wherein the user interface additionally allows a user to change other characteristics of the at least one peripheral zone in addition to changing size.
